(19) United States
(12) Patent Application Publication
(10) Pub. No.: US 2012/0003465 A1
(43) Pub. Date: Jan. 5, 2012

(54) SINTERING MATERIAL, SINTERED BOND AND METHOD FOR PRODUCING A SINTERED BOND

(76) Inventors: Martin Rittner, Freiberg (DE); Michael Guenther, Stuttgart (DE)

(21) Appl. No.: 13/144,469

(22) PCT Filed: Jan. 4, 2010
(86) PCT No.: PCT/EP10/50013

§ 371 Date: Sep. 21, 2011

(30) Foreign Application Priority Data
Jan. 14, 2009 (DE) 102009000192.1

(51) Int. Cl. B22F 1/02; B23K 1/20; B32B 5/16; B23K 35/24

(52) U.S. Cl. 428/323; 75/252; 75/255; 148/24; 228/248.5

(57) ABSTRACT

A sintering material having metallic structural particles which are provided with an organic coating. Non-organically coated, metallic and/or ceramic auxiliary particles are provided that do not outgas during the sintering process. A sintered bond, as well as a method for producing a sintered bond.

### FIELD OF THE INVENTION

The present invention relates to a sintering material for sintering together two join partners, a sintered bond, and to a method for producing a sintered bond.

### BACKGROUND INFORMATION

Currently, lead-free soldered connections are used for joining electronic components to another join partner. It is also conventional to use silver sintering technology for applications characterized by high power losses and high ambient temperatures, as is described in the German Patent Application No. DE 43 15 272 A1, for example. The liquid phase in the sinter joining process is bypassed through the use of high-melting metals or metal alloys in the form of solid particles. It is thus possible to produce a sintered bond that is high-temperature resistant, that ensures an electrical and thermal contacting and, at the same time, that avoids high joining temperatures for fusing the silver sintering paste used.

Since high process pressures are used for the conventional silver sintering method, current efforts are directed to reducing these pressures. One approach provides for using very small structural particles in order to use the thereby increased surface energy as a driving force for the sintering process. Structural particles in the nanometer range are even used. Besides the metallic structural particles having a wax-like coating, the conventional sintering pastes normally also contain organic solvents in order to ensure the pasty properties thereof. Other chemical compounds or organic fillers are also often optionally present.

By using ever smaller metallic structural particles, an ever greater proportion of organic components in the sintering paste is obtained, while the metal content declines. Since the organic components must be removed during the joining process (sintering process) in order to induce a sintering of the individual structural particles, an ever greater organic content must be vaporized, respectively burned. The result is that a very substantial gas volume must be removed from the sinter layer which leads to pores forming in the joining layer (sinter layer). Up to a certain concentration, these pores can be advantageous, as long as they are uniformly distributed. At higher organic contents, large gas bubbles form, most notably in the middle region of the sinter layer, and they remain in the sinter layer. Since, in addition to an electrical and mechanical contacting, the sinter layer must also ensure a thermal dissipation by way of thermal conductivity, in particular when a power semiconductor is connected via the sinter layer to another join partner, these gas bubbles, which, in the extreme case, can even attain the dimensions of the layer thickness, are disadvantageous.

The high process pressure required in a sintering method described, for example, in European Patent Application No. EP 0 330 895 B1 can be applied uniaxially or isostatically. In the complex isostatic method, the join must be encapsulated in a silicon material, for example, during pressure application, to prevent the sintering paste from being squeezed out on the sides. In a uniaxial pressure application, the joining force is limited since the sintering paste can be squeezed out if there is no encapsulation. The workability of the sintering paste and its dimensional stability when applied, in particular pressed, are in direct contradiction to each other. The viscosity of the sintering paste and thus the ease of application, in particular the compressibility are ensured by a high organic content. At the same time, these viscous properties are disadvantageous in the context of a requisite joining pressure since the sintering paste can still spread in the initial stage.

### SUMMARY

It is an object of the present invention to provide a sintering material that may be used to reduce the formation of gas during the sintering process. The sintering material should preferably be formed in a way that even makes it possible to substantially prevent the sintering material from being squeezed out laterally when pressure is applied to the join partners. It is also an object to provide an optimized sintered bond where the sinter layer does not contain any excessively large gas bubbles. It is especially preferred if the sintered bond be producible even at high process pressures without having to provide an encapsulation of the sintering material. It is also an object to provide a method for producing a sintered bond, the aim of the method being to prevent an extreme gas formation in the sinter layer during the sintering process. It is preferred that the method permit a sintering of at least two join partners using sintering material without having to encapsulate the sintering paste prior to the pressure application.

Any combinations of at least two of the features described in the specification and/or the figures come under the scope of the present invention. To avoid repetitive descriptions, features described in method terms shall also be considered as described in device terms. In the same way, features described in device terms shall also be considered as described in method terms.

With regard to producing an advantageous sintering material, the idea underlying the present invention is that auxiliary particles also be provided, in addition to the metallic structural particles provided with an organic coating, in particular copper, silver and/or gold particles, the auxiliary particles being metallic and/or ceramic particles which, in contrast to the structural particles, are not organically coated, in order to thereby avoid the formation of gas during the sintering process. Depending on the purpose of the application, the auxiliary particles may be used as fine powder, as granulate or as powder-granulate mixture. Integrating the aforementioned auxiliary particles into the sintering material reduces the organic content of the sintering material, making it possible to selectively control the desired pore size. A similar effect may be achieved in the case of a sintered bond that is formed in accordance with the present invention and is explained further below, in that the auxiliary particles are provided in the region of the join between at least two join partners, it not being absolutely necessary in this case for the auxiliary particles to be introduced beforehand into the sintering material—a direct introduction/deposition into the join, respectively onto at least one join partner is possible. The auxiliary particles used for the sintering material do not necessarily have to be uniform—it may also be a question of a mixture of metallic and ceramic particles or a mixture of various metallic and/or ceramic particles. As previously explained, the proportion of organic components in the sintering material may be reduced by providing auxiliary particles, resulting in a smaller gas volume that must be removed from the paste volume. This leads to a smaller concentration of pores, respectively to a reduction of large-volume pores and thus to an improved thermal dissipation from the sintered bond to be produced. In addition, the auxiliary particles may induce a change in the thermal expansion coefficient of the sintering material. This is advantageous in terms of the resistance of the bond of join partners and sintering material to temperature fluctuations. It is especially preferred that the thermal expansion properties be reduced by using ceramic auxiliary particles since the sinter layer (bonding layer) may be adapted in this manner to the expansion coefficient of the semiconductor elements to be added. In addition, the sintering gap may be selectively controlled by providing the auxiliary particles in the previously described form in the sintering material and/or directly on at least one of the join partners. For this application purpose, the particle size of the auxiliary particles preferably exceeds by many times that of the structural particles. By selecting the particle size and the proportion of auxiliary particles, a minimal distance may be selected between the join partners. Thus, in spite of a requisite joining pressure, a minimal gap width is ensured between the join partners since a further compression of the join partners is prevented by one or more layers of the auxiliary particles. A greater dimensional stability is thereby achieved, especially of the compressed structure. It is possible to thereby control or minimize the process of squeezing out the sintering material having the auxiliary particles. In the least favorable case, a pressing out of the sintering material may lead to a short circuit.

The sintering material is preferably sintering paste, especially silver sintering paste, it also being preferred that the sintering paste contain organic solvents for ensuring the pasty properties. In accordance with one alternative specific embodiment, the sintering material may also be a powder mixture. A specific embodiment may also be realized where the sintering material is formed as a sintering material blank (preform), thus already as a shaped body.

The sintering material formed in accordance with the present invention is preferably used for products which require an electrical connection to electrical components. In particular, soldered connections used in conventional methods heretofore may be substituted by a sintered bond produced by a sintering material formed in accordance with the present invention. The sintered bond produced using the sintering material may be employed at high temperatures and/or for components having high power losses. Service-life limitations occurring in conventional methods heretofore may be overcome by the sintering material that is produced in accordance with the present invention. This is especially possible when the auxiliary particles are formed as spacer elements since a defined gap dimension may be observed in spite of a high process pressure. Exemplary fields of application include: power output stages of electrical power steering systems, power output stages of universal inverter units, control electronics, particularly at the starter and/or generator, press-in diodes on generator shields, high-temperature stable semiconductors, such as silicon carbide, or also sensors that are operated under a high temperature and require an evaluation electronics proximate to the sensor. A use for semiconductor diodes is also possible. The sintering material may also be used for inverter modules, particularly in photovoltaic systems.

Since the auxiliary particles make it possible for a low concentration of pores to be adjusted and for suitable thermal expansion coefficients to be realized, higher application temperatures may be realized for the sintered bond that is obtained. By minimizing the pores, the joining surface may also be increased which, at the present time, is limited by the degasification problems. This makes it possible to achieve optimal heat transfer properties.

In a further refinement of the present invention, the auxiliary particles have the feature that their melting temperature is higher than a sintering process temperature in order to avoid a fusing of the auxiliary particles during the sintering process. It is particularly preferred if the melting temperature of the auxiliary particles be higher than that of the structural particles used. It is especially preferred if the temperature used during the sintering process be below 300° C., preferably below 250° C., and particularly below 100° C. From a technical standpoint, it is desirable that the process pressure used be zero which, however, is hardly feasible. The process pressure is preferably maximally 40 MPa, preferably less than 15 MPa, more preferably less than 10 MPa, or less than 6 Mpa, or less than 3 MPa, or less than 1 MPa, or less than 0.5 MPa.

It is especially useful if the auxiliary particles be formed to be sintered with the structural particles during the sintering process. To this end, the auxiliary particles may have a sinterable surface, for example, which may be realized using a suitable coating, for example. It is also possible to select the auxiliary particles in such a way that they diffuse into the structural particles.

It is especially preferred when the auxiliary particles are ceramic and/or metallic particles. In the case that auxiliary particles are provided, it may be advantageous to coat the same, in particular metallically, preferably with a metal and/or a noble metal or with nickel, especially with a nickel having a phosphorus content. This makes it possible to improve the adhesion of the auxiliary particles in the sintering material. When metal particles are used as auxiliary particles, they may be formed from the same material as the structural particles (however, without any organic coating). This actually does not effect any change in the thermal expansion properties, however, it does reduce the volume of the gases formed during the sintering process, resulting in a denser sinter layer.

With regard to forming the structural particles, there are likewise different options. One specific embodiment is particularly preferred where the structural particles are silver particles. Additionally or alternatively, structural particles formed as copper particles, gold particles or palladium particles may be provided. It is also possible to use a mixture of the aforementioned particles as structural particles. Additionally or alternatively, it is possible to produce the structural particles from alloys which preferably contain at least one of the aforementioned metals.

When ceramic particles are used as auxiliary particles, the thermal conductivity of the auxiliary particles should be ensured. Therefore, materials such as aluminum oxide (also doped), aluminum nitride, beryllium oxide and silicon nitride are also suited here. In order not to degrade the electrical conductivity of ceramic auxiliary particles, electrically conductive ceramics, such as boron carbide or silicon carbide, may be used.

Especially preferred in this context is a specific embodiment in which the auxiliary particles are formed as shaped bodies having specific geometric shapes. Thus, it is possible, for example, to contour the auxiliary particles to be spherical, cuboidal, cylindrical, etc. This may be accomplished, for example, by punching the auxiliary particles out of sheet metal, it being especially preferred in this case when the sheet metal, respectively the shaped bodies are provided with a coating which makes it possible for the auxiliary particles to be sintered with the structural particles, in no case, however, the coating being able to be of an organic nature in order not to additionally produce a gas volume during the sintering process. The use of irregularly contoured auxiliary particles as spacer elements is also possible. It is especially preferred when the auxiliary particles have a substantially larger, in particular many times larger particle size than the structural particles. It is particularly preferred for the auxiliary particles to be selected to be of such a size that they simultaneously contact both join partners to be joined together and thus directly define the gap width.

The present invention also relates to a sintered bond, including at least two join partners which are sintered together in one join region. As described above, it is a feature of the sintered bond that the described auxiliary particles for the sintering material are provided in the join region and that, by reducing the organic content, they make it possible in the first instance to avoid an excessive gas production and that, given an appropriate particle size, they assume a spacer element function to adjust the join gap.

If the auxiliary particles are formed as spacer elements, it is preferred that the auxiliary particles have a substantially larger, in particular many times larger particle size than the structural particles. In one especially preferred specific embodiment, the auxiliary particles simultaneously contact both join partners.

With regard to forming the at least two sintered together join partners, there are different options. Thus, at least one of the join partners may be in the form of an electronic component, in particular a semiconductor component, preferably a power semiconductor component. It is especially preferred in this context that this component contain silicon, silicon carbide, silicon nitride, gallium phosphide or gallium arsenide. It is also preferred when a component of this kind is joined by a sinter layer to an electrical circuit substrate. It is also possible to use a sinter layer to sinter an, in particular, populated circuit substrate and a base plate and/or a housing. A component, in particular an electronic component, having two sinter layers which preferably face away from one another, may also be introduced in a sandwich-type configuration between two join partners that ensure a top and/or bottom electrical contacting of the component. In the case that one of the join partners is formed as a base plate, it is preferred that it be in the form of what is generally referred to as a DCB substrate, an AMB substrate, an IMS substrate, a PCB substrate, an LTCC substrate or a standard ceramic substrate.

The present invention also relates to a method for producing a sintered bond. It encompasses at least two join partners that have been sintered together in a sintering process using sintering material. The central idea is to provide auxiliary particles that have been formed in the manner described in the preceding or in the claims; in the join region, it being possible to use a sintering material provided with auxiliary particles of this kind and/or the auxiliary particles as such, that are applied either to at least one of the join partners in the join region and/or to the applied, in particular pressed-on sintering material. The aim of providing the auxiliary particles is to avoid an excessive gas bubble formation by reducing the organic content. Depending on the particle size of the auxiliary particles, they may also be used to adjust the distance, i.e., the gap dimension between the join partners.

Other advantages and features of the present invention and details pertaining thereto are derived from the following description of preferred exemplary embodiments, as well as in light of the figures.

### BRIEF DESCRIPTION OF THE DRAWINGS

FIG. 1 shows one possible specific embodiment of a sintered bond having two join partners.

FIG. 2 shows one alternative specific embodiment of a sintered bond having altogether three join partners and two sinter layers.

FIG. 3 shows one alternative sintered bond where spherical auxiliary particles are provided as spacer elements.

FIG. 4 shows another alternative sintered bond where the spherical sinter particles used as spacer elements are particles that are provided with a non-organic coating.

FIG. 5 shows another alternative exemplary embodiment of a sintered bond where the auxiliary particles used as spacer elements have a cuboidal shape.

FIG. 6 shows another alternative exemplary embodiment of a sintered bond where the auxiliary particles are formed as coarse-grained powder.

FIG. 7 shows a representation of a sintered bond having spherical auxiliary particles which join together two sinter layers.

### DETAILED DESCRIPTION OF EXAMPLE EMBODIMENTS

In the figures, equivalent elements and elements performing equivalent functions are denoted by the same reference numerals.

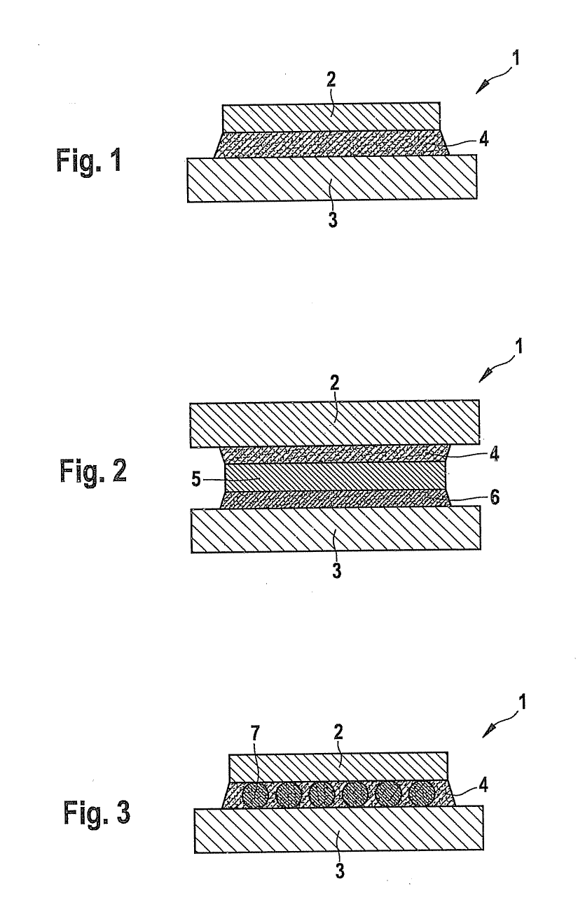

FIG. 1 shows a sintered bond 1. It encompasses a first join partner 2 in the top of the drawing plane, as well as a second join partner 3 located thereunder. The two join partners 2, 3 are sintered to one another via a sinter layer 4 produced from a sintering material (not shown). Prior to the sintering process, the sintering material and, following the sintering process, the resultant sinter layer 4 contain auxiliary particles that were/are non-organically coated, in addition to the metallic structural particles. The sintering material used may alternatively be a sintering paste, a powder mixture or a sintered shaped part. The auxiliary particles are used for reducing the organic content and thus for reducing the gas formation during sintering of the sinter partners. The auxiliary particles generally have the feature that they are inert relative to the sintering process, i.e., that they outlast it at least roughly unchanged. First join partner 2 is an electronic component, for example a power semiconductor, and, in the case of second join partner 3, a circuit substrate, for example. It is also possible that first join partner 2 is a populated circuit substrate and that second join partner 3 is a base plate (heat sink).

FIG. 2 shows an alternative sintered bond 1. Besides the first two, externally configured join partners 2, 3, this includes a third join partner 5, which, in the illustrated exemplary embodiment, is an electronic component, for example. The first and second join partner 2, 3 are preferably each formed as a circuit substrate or base plate or housing, etc. A sinter layer 4, 6, which was produced in each case from a sintering material, is located between first join partner 2 and third join partner 5, as well as between third join partner 5 and second join partner 3. This sintering material contains metallic or ceramic, non-organically coated auxiliary particles which do not outgas during the sintering process under the application of pressure and temperature.

Other exemplary embodiments of sintered bonds 1, including two each of join partners 2, 3 joined together by sintering, are shown in FIG. 3 through 6. Sinter layer 4 located between join partners 2, 3 was produced in each case from a sintering material (for example, a sintering paste, a powder mixture or a sintered shaped part) encompassing metallic or ceramic, non-organically coated auxiliary particles 7 that do not outgas during the sintering process. In the exemplary embodiments in accordance with FIG. 3 through 6, auxiliary particles 7 are used as spacer elements for adjusting the gap dimension of the sintering gap, respectively the layer thickness of sinter layer 4. In all the exemplary embodiments in accordance with FIG. 3 through 6, schematically illustrated auxiliary particles 7 have a substantially larger particle size than the structural particles of sinter layer 4 (not sketched for reasons of clarity). Auxiliary particles 7 generally have the feature that they are inert relative to the sintering process, i.e., that they outlast it at least mostly unchanged.

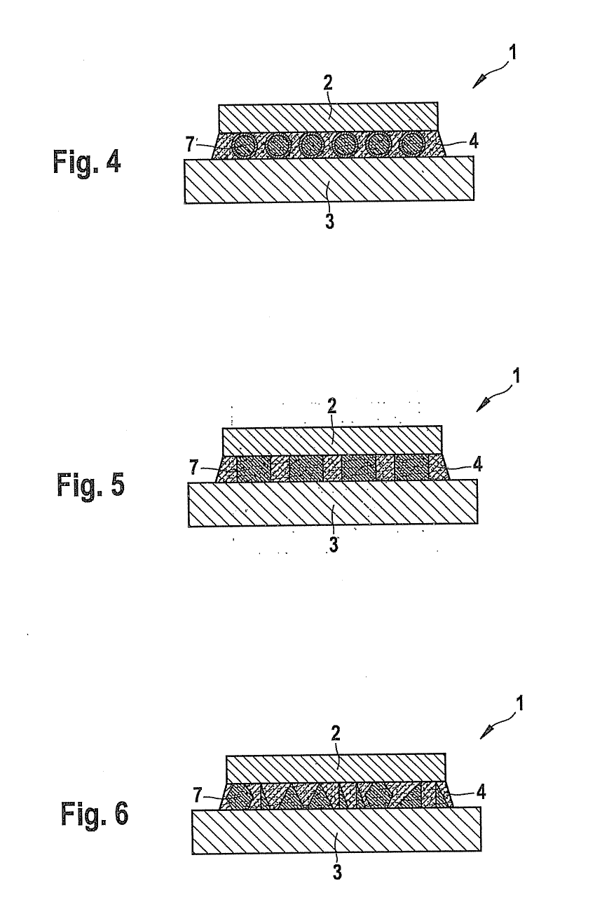

In the exemplary embodiment in accordance with FIG. 3, auxiliary particles 7 have a spherical shape, just as in the exemplary embodiment in accordance with FIG. 4, with the distinction that, in the exemplary embodiment in accordance with FIG. 4, auxiliary particles 7 are coated. It is preferably a question of metallically coated ceramic particles.

In the exemplary embodiment in accordance with FIG. 5, auxiliary particles 7 having a cuboidal or cylindrical contour are provided and, in the exemplary embodiment in accordance with FIG. 6, a coarse-grained powder, the individual auxiliary particles 7 being irregularly contoured.

In the case of auxiliary particles 7 shown in FIG. 3 through 7, it may be a question of shaped bodies, for example, which are then punched from sheet metal, for example. These shaped bodies are preferably provided with a coating (surface finish), as is illustrated in FIG. 4, for example, in order to be able to enter into a permanent bond with the structural particles of the sintering material, respectively sinter layer.

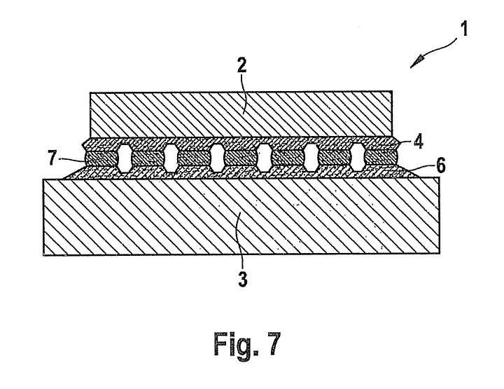

FIG. 7 shows a another exemplary embodiment of a sintered bond 1. Discernible are two join partners 2, 3 which are permanently bonded together by sintering, one sinter layer 4, 6 being formed in each case on one side of each join partner 2, 3; in the illustrated exemplary embodiment, sinter layers 4, 5 not contacting one another directly, rather being joined to one another via auxiliary bodies 7 having comparatively large dimensions, auxiliary bodies 7 being sintered to the structural particles of sinter layers 4, 6.

1-12. (canceled)

13. A sintering material, comprising:
metallic structural particles which are provided with an organic coating; and
non-organically coated auxiliary particles, the auxiliary particles being one of metallic and ceramic and not releasing any gas during a sintering process, the auxiliary particles having one of a spherical, a cuboidal, a cylindrical or an irregularly contoured shape and having a particle size that is greater than a particle size of the structural particles.

14. The sintering material as recited in claim 13, wherein the sintering material is formed as one of a sintering paste containing at least one organic solvent, a powder mixture, or a sintering material preform.

15. The sintering material as recited in claim 13, wherein a melting temperature of the auxiliary particles is higher than a sintering process temperature.

16. The sintering material as recited in claim 14, wherein the melting temperature of the auxiliary particles is higher than a melting temperature of the structural particles.

17. The sintering material as recited in claim 13, wherein a decomposition temperature of the structural particles is higher than a decomposition temperature of the structural particles.

18. The sintering material as recited in claim 13, wherein the auxiliary particles are formed in such a way that the auxiliary particles sinter with the structural particles during a sintering process by at least one of: i) providing a sinterable surface or coating, and ii) inward diffusion.

19. The sintering material as recited in claim 13, wherein the auxiliary particles are at least one of metallic and ceramic coated.

20. The sintering material as recited in claim 13, wherein the auxiliary particles are coated with a metal of the structural particles.

21. The sintering material as recited in claim 13, wherein the auxiliary particles are coated with one of a noble metal or nickel having a phosphorus content.

22. The sintering material as recited in claim 13, wherein the structural particles include at least one of silver particles, copper particles, gold particles, platinum particles, and palladium particles.

24. The sintering material as recited in claim 13, wherein the structural particles are formed as a alloy of at least one of silver particles, copper particles, platinum and palladium particles.

25. The sintering material as recited in claim 13, wherein the auxiliary particles include at least one of tungsten particles, gold particles, silver particles, aluminum oxide particles, aluminum nitride particles, beryllium oxide particles, silicon nitride particles, boron carbide particles, and silicon carbide particles.

26. A sintered bond, comprising:
a first join partner and at least one second join partner sintered together in a join region; and
auxiliary particles provided in the join region, wherein the auxiliary particles are non-organically coated prior to and following a sintering process and do not release any gas during the sintering process, and wherein a particle size of the auxiliary particles is larger than a particle size of the structural particles.

27. The sintered bond as recited in claim 26, wherein at least a portion of the auxiliary particles contacts both the first join partner and the second join partner.

28. The sintered bond as recited in claim 27, wherein more than half of the auxiliary particles contacts both the first join partner and the second join partner.

29. The sintered bond as recited in claim 26, wherein at least one of the first join partner and the second join partner is coated with at least one of nickel-phosphorus, silver and gold.

30. The sintered bond as recited in claim 29, wherein at least one of the first join partner and the second join partner is one of: i) an electronic component formed of one of silicon, silicon carbide, gallium nitride, gallium indium phosphite, and gallium arsenide, ii) a populated circuit substrate, iii) a housing, or iv) a base plate formed as one of a DCB, AMB, IMS, PCB, LTCC or standard ceramic substrate.

31. A method for producing a sintered bond, comprising:
sintering a first join partner and at least a second join partner together using a sintering material in a sintering process under the action of pressure and temperature using a sintering material; and
providing non-organically coated auxiliary particles, which do not release any gas during the sintering process, in a join region on at least one of the first join partner and the second join partner prior to application of the sintering material.
